(19) United States
(12) Patent Application Publication
(10) Pub. No.: US 2008/0128994 A1
(43) Pub. Date: Jun. 5, 2008

(54) Mechanical face seal, mechanical face seal arrangement and its use

(75) Inventors: Clemens Simon, Stamberg (DE); Klaus Lang, Beuerberg (DE); Peter Feigl, Hoehenrain (DE)

Correspondence Address: Davidson, Davidson & Kappel, LLC, 485 7th Avenue, 14th Floor, New York, NY, 10018, US

(73) Assignee: Carl Freudenberg KG, Weinheim (DE)

(21) Appl. No.: 11/983,661

(22) Filed: Nov. 9, 2007

(30) Foreign Application Priority Data
Nov. 9, 2006 (DE) 102006053165.5-12

(51) Int. Cl. F16J 15/34

(52) U.S. Cl. 277/348

(57) ABSTRACT

A mechanical face seal is provided that surrounds a shaft that is to be sealed, the mechanical face seal includes a stationary seal ring wherein the shaft is integral to the mechanical face seal, is configured in one piece, makes a transition to the stationary seal ring and includes the same material as the ring.

This application claims the benefit of German Patent Application No. DE 10 2006 053 165.5-12 filed Nov. 9, 2006 and hereby incorporated by reference herein.

The invention relates to a mechanical face seal, to a mechanical face seal arrangement and to its use.

### BACKGROUND INFORMATION

Mechanical face seals and mechanical face seal arrangements are generally known, for example, from German patent specification DE 44 15 115 C1. The mechanical face seal comprises a stationary seal ring and a set collar that are relatively non-rotatably joined to each other and, around the circumference, said mechanical face seal relatively non-rotatably surrounds a shaft that is to be sealed. The set collar is relatively non-rotatably joined to the shaft by several helical fastening elements that are distributed uniformly in the circumferential direction, whereby the stationary seal ring is sealed vis-à-vis the set collar and the set collar is sealed vis-à-vis the shaft by O-rings made of elastomeric material. In order to ensure a non-rotatable positioning of the stationary seal ring relative to the set collar, pin-shaped catches are provided that extend in the axial direction.

### SUMMARY OF THE INVENTION

An object of the present invention is to refine a mechanical face seal and a mechanical face seal arrangement of the prior-art type in such a way that they have a much simpler structure, comprising fewer parts, and that can consequently be produced more simply and cost-effectively from a manufacturing and financial standpoint. The risk of assembly errors is to be reduced to a minimum.

According to the present invention, the mechanical face seal surrounds a shaft that is to be sealed. The mechanical face seal also includes a stationary seal ring. The shaft is an integral part of the mechanical face seal and is configured in one piece. The shaft makes a transition to the stationary seal ring and is made of the same material as the stationary seal ring.

In order to achieve the objective, a mechanical face seal can be provided that surrounds a shaft that is to be sealed, encompassing a stationary seal ring, whereby the shaft is an integral part of the mechanical face seal and is configured in one piece, making a transition to the stationary seal ring and consisting of the same material. Here, it is advantageous for the stationary seal ring and the shaft to form a unit that, since it is made in one piece, does not require any separate gaskets for sealing purposes. Moreover—in contrast to the above-mentioned mechanical face seal known from the state of the art—there is no need for anti-twist protection between the set collar and the shaft or between the set collar and the stationary seal ring, that would serve to ensure that the shaft and the stationary seal ring are arranged non-rotatably relative to each other.

Moreover, it is advantageous that the production of the mechanical face seal and of the mechanical face seal arrangement is simplified in that the one-piece unit can be balanced much more easily than a shaft onto which separately manufactured components such as, for example, a set collar or a stationary seal ring, have been positively or non-positively attached.

The unit that is formed by the stationary seal ring and by the shaft is preferably made of tempered steel. Such a unit can be manufactured cost-effectively since it can be produced preferably by machining, especially by means of turning on a lathe. In order to achieve the required sealing effect, the sealing surface of the stationary seal ring has to be of high quality, and this can be achieved by using the manufacturing method of “hard turning” in that the work is carried out with only a slight advance. In conjunction with high-quality turning machines and hard grades of tool steel, surfaces can then be produced that, with greatly simplified production, have the same good properties of use as lapped or polished surfaces.

The stationary seal ring has a first sealing surface that lies elastically and resiliently against a second sealing surface of a mechanical face seal in the axial direction so as to seal it.

At least the first sealing surface has a peak-to-valley height Ra of 0.1 to 0.3. Such a surface roughness can be achieved by the above-mentioned hard turning and is completely sufficient for use in mechanical face seals in order to achieve a good sealing effect.

The first sealing surface can have cutouts that extend essentially in the radial direction, that are arranged adjacent to each other uniformly in the circumferential direction and that allow gas to pass through; preferably the cutouts are arc-shaped. This is advantageous especially if the above-mentioned mechanical face seal or the above-mentioned mechanical face seal arrangement is used in gas turbines. It is a generally known approach to provide the sealing surface of stationary seal rings with cutouts that allow gas to pass through, for example, as in EP 1 054 196 A2. These cutouts that allow gas to pass through ensure that the gaseous medium that is to be sealed remains largely free of non-gaseous constituents such as, for example, oil particles. Owing to these cutouts that allow gas to pass through, it is achieved that, in all operating states of the mechanical face seal, a sufficiently stable gas cushion exists between the sealing surfaces of the stationary seal ring and of the face seal ring, whereby, as a result of the design of the cutouts that allow gas to pass through, the leakage loss is minimized and a leakage flow from the space that is to be sealed off in the direction of the environment prevents non-gaseous constituents from penetrating between the sliding surfaces. Cutouts that allow gas to pass through can be used in gas-lubricated mechanical face seals.

### BRIEF DESCRIPTION OF THE DRAWINGS

An embodiment is explained in greater detail below on the basis of the schematically depicted FIGS. 1 and 2.

The figures show:

FIG. 1: a longitudinal section through a mechanical face seal arrangement,

FIG. 2: the unit, comprising the face seal ring and the shaft, along the section A-A of FIG. 1,

FIG. 3: an embodiment of a double mechanical face seal in a symmetrical configuration,

FIG. 4: a double mechanical face seal arranged behind each other,

FIG. 5: a mechanical face seal in a coaxial arrangement and

FIG. 6: a mechanical face seal arranged against an axial bearing.

### DETAILED DESCRIPTION OF THE DRAWINGS

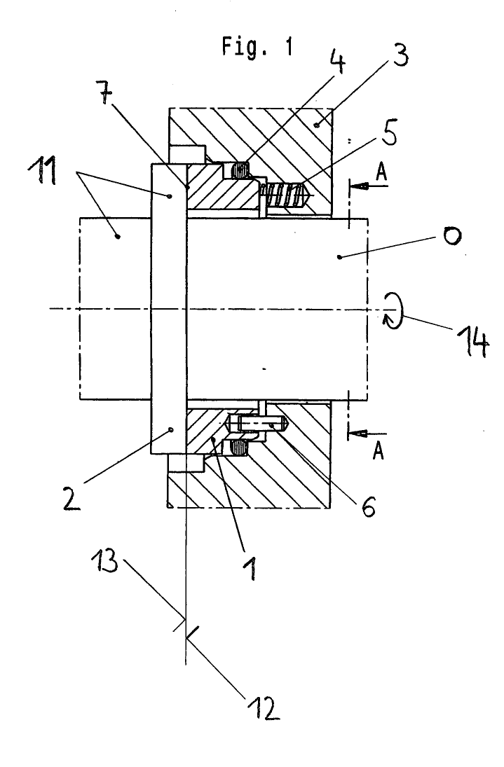

FIG. 1 shows an embodiment of a mechanical face seal arrangement according to the invention that encompasses the mechanical face seal according to the invention. The shaft 0 that is to be sealed and the stationary seal ring 2 are configured in one piece, making a transition to each other and consisting of the same material, and together, they form the unit 11. The stationary seal ring 2 and the shaft 0 are made of tempered steel and were machined by means of hard turning.

Only a slight advance is used for the turning when the unit 11 is machined, so that the first sealing surface 12 of the stationary seal ring 2 can be produced with a peak-to-valley height Ra amounting to 0.1 to 0.3. Such a peak-to-valley height can be created by the inexpensive manufacturing method of “hard turning” and it is sufficiently smooth to impart good properties of use to the mechanical face seal.

The face seal ring 1 has a second sealing surface 13 that lies elastically and resiliently against the first sealing surface 12 of the stationary seal ring 2 in the axial direction so as to seal it. In the embodiment shown here, the face seal ring 1 is arranged in a housing 3 that is penetrated by the shaft 0 that is to be sealed. The face seal ring 1 is sealed vis-à-vis the housing 3 by an O-ring 4. The housing 3 and the face seal ring 1 are stationary, relative to the stationary seal ring 2 that rotates with the shaft 0.

The elastic contact pressure of the first sealing surface 12 of the stationary seal ring 2 against the second sealing surface 13 of the face seal ring 1 is effectuated by a compression spring 5 that is mounted inside the housing 3.

It is a noteworthy advantage that, owing to fact that the configuration of the unit 11 is in one-piece and is consists of the same material, in this area, there is no need to provide seals that would have to be produced and mounted separately in order to seal the shaft 0 vis-à-vis the stationary seal ring 2. The unit 11 is simple and inexpensive to produce, to mount and, all in all, it has compact dimensions, especially in the axial direction.

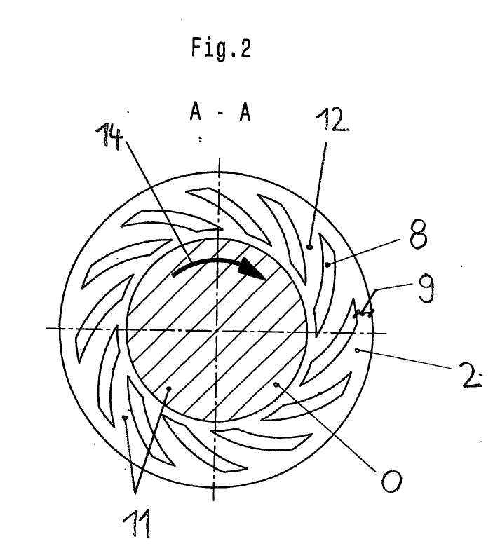

FIG. 2 shows the section A-A from FIG. 1, whereby in FIG. 2, for the sake of greater clarity, only the unit 11, consisting of the stationary seal ring 2 and the shaft 0, is shown. The first sealing surface 12 is provided with cutouts 8 that extend essentially in an arc in the radial direction, that are arranged adjacent to each other uniformly in the circumferential direction 14 and that allow gas to pass through. The cutouts 8 that allow gas to pass through cause a gas to be pumped between the sealing surfaces 12, 13 when the shaft 0 rotates, as a result of which pressure builds up between said sealing surfaces 12, 13, which leads to the separation of the sealing surfaces 12, 13, thereby forming a gas cushion between the sealing surfaces 12, 13.

The cutouts 8 that allow gas to pass through are produced by means of a lathe tool that executes a back-and-forth motion synchronously to the rotational motion. This motion corresponds to the depth course of the cutouts 8 along a circumferential line. When the lathe tool rotates, it penetrates the workpiece in accordance with the number of cutouts 8. Since the synchronized oscillation motion is also offset in the phase during the face turning, the cutouts 8 that are formed are not straight but rather arc-shaped. Fundamentally, however, through appropriate control of the tool motion, any desired 3D shape can be created for the cutouts 8. The control can be effectuated by fast CNC axes. CPUs carry out the coordination.

The decisive factor is that the cutouts 8 and the first sealing surface 12 of the stationary seal ring 2 are produced in a clamping set-up since this is the only way in which the requisite precisions can be achieved. The cutouts 8 are configured in such a way that they form a sealing dam 9 along the circumference of the stationary seal ring 2.

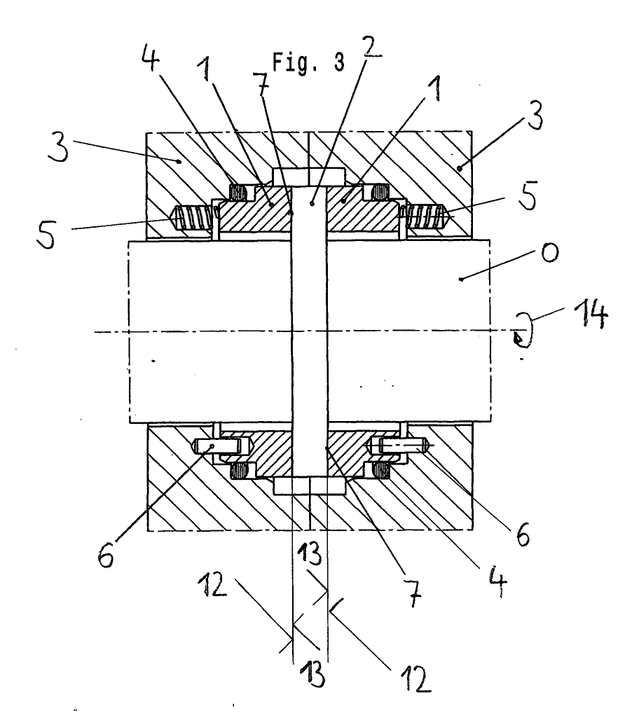

FIG. 3 shows a double mechanical face seal in a symmetrical configuration, whereby two face seal rings 1.1, 1.2 lie against a shared stationary seal ring 2 that makes a transition to the shaft 0 and that consists of the same material, as is also shown in FIG. 1.

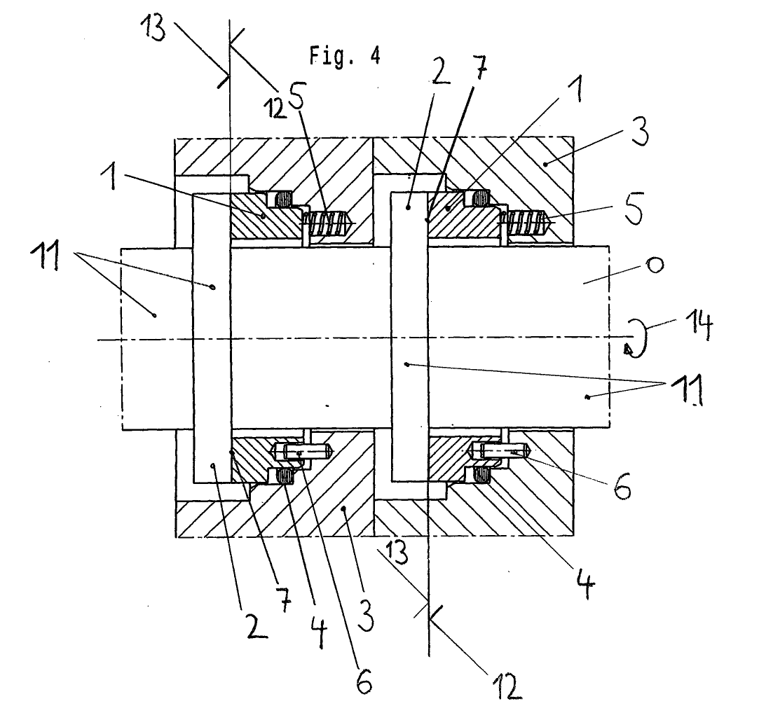

FIG. 4 shows a double mechanical face seal in which two mechanical face seals, each corresponding to the mechanical face seal of FIG. 1, are arranged one after the other in a functional series connection.

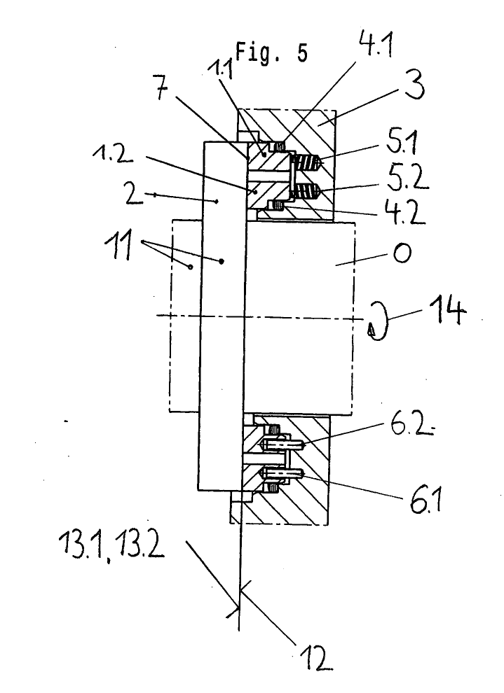

FIG. 5 shows a mechanical face seal in a coaxial arrangement. In addition to the mechanical face seal that is shown in FIG. 1, a second face seal ring 1.2 is provided that is surrounded by the first face seal ring 1.1 at a radial distance on the outside of the circumference. The two face seal rings 1.1, 1.2 are arranged coaxially with respect to each other and, with their second sealing surfaces 13.1, 13.2, lie against the first sealing surface 12 of the stationary seal ring 2 so as to seal it.

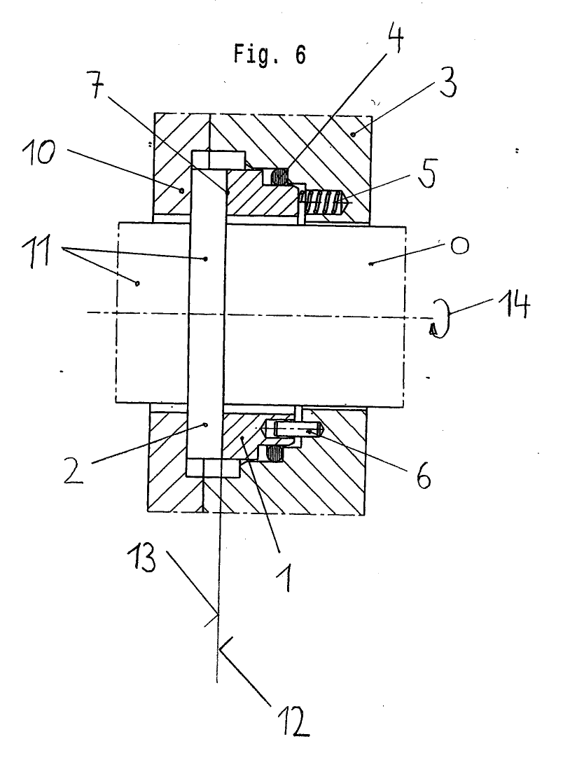

FIG. 6 shows a mechanical face seal as depicted in FIG. 1, which is arranged against an axial bearing 10.

What is claimed is:

1. A mechanical face seal that surrounds a shaft that is to be sealed, the mechanical face seal comprising:
a stationary seal ring wherein the shaft is integral to the mechanical face seal, is configured in one piece, makes a transition to the stationary seal ring and is comprised of the same material as the stationary seal ring.

2. The mechanical face seal according to claim 1, wherein the stationary seal ring and the shaft form a unit comprised of tempered steel.

3. The mechanical face seal according to claim 2, wherein the unit is produced by machining.

4. The mechanical face seal according to claim 2, wherein the unit is produced by turning on a lathe.

5. The mechanical face seal according to claim 1, wherein the stationary seal ring comprises a first sealing surface lying elastically and resiliently against a second sealing surface of a face seal ring in the axial direction so as to seal it.

6. The mechanical face seal according to claim 5, wherein the first sealing surface comprises a peak-to-valley height Ra of 0.1 to 0.3.

7. The mechanical face seal according to claim 5, wherein the first sealing surface comprises cutouts that extend at least in the radial direction;
wherein the cutouts are arranged adjacent to each other uniformly in a circumferential direction and allow a gas to pass through.

8. A method for the production of a mechanical face seal according to claim 7;
wherein the unit comprises the shaft, the face seal ring and cutouts in the face seal ring which allow a gas to pass through; and
wherein the unit is produced in only one clamping set-up by turning on a lathe.
